(19) United States
(12) Patent Application Publication
(10) Pub. No.: US 2007/0064987 A1
(43) Pub. Date: Mar. 22, 2007

(54) System for processing imaging device data and associated imaging report information

(76) Inventors: Matthew Paul Esham, Pennsville, NJ (US); Jeffrey Granito, Norristown, PA (US)

Correspondence Address: Siemens Corporation;Intellectual Property Department, 170 Wood Avenue South, Iselin, NJ, 08830, US

(21) Appl. No.: 11/366,067

(22) Filed: Mar. 2, 2006

Related U.S. Application Data
(60) Provisional application No. 60/667,946, filed on Apr. 4, 2005.

(51) Int. Cl. G06K 9/00

(52) U.S. Cl. 382/128

(57) ABSTRACT

A system uses imaging device orientation, location and inclination data to create a link between a medical report statement and a specific image or series of images enabling a user to view a patient imaging report of a patient automatically associating a patient image and a corresponding report statement. A system identifies an anatomical portion of a patient using positional data derived from an imaging device. The system includes an acquisition processor for acquiring positional data of a directional image acquisition unit oriented to acquire an image of a particular anatomical portion of a patient. The positional data corresponds to a particular orientation used to acquire a particular image of the particular anatomical portion of the patient. A repository of mapping data links positional data of the image acquisition unit with data identifying anatomical portions of a patient. An image data processor associates the particular image derived using the image acquisition unit with a particular anatomical portion of a patient using the mapping data.

This is a non-provisional application of provisional application Ser. No. 60/667,946 by M. P. Esham et al. filed Apr. 4, 2005.

### FIELD OF THE INVENTION

This invention concerns a system for automatically identifying and associating an anatomical portion of a patient and related medical image representative data with positional data derived from an imaging device.

### BACKGROUND OF THE INVENTION

In using existing medical image acquisition and processing systems such as MRI, CT scan, X-ray, ultrasound, fluoroscopy or other imaging systems, a user typically has to manually parse through an image study of a particular patient in reading and interpreting an associated medical report concerning the image study of the patient. A user needs to look for one or more images associated with an individual statement made in an imaging report for a patient, for example. In a web based deployment, a user views a web based medical report and launches a web based image viewer to view an image study of a patient. In an example a user reading an imaging report needs to subsequently page through fluoroscopy images manually to see images concerning a particular statement in the report. The user needs to page through multiple images that are not relevant or of interest to find one or more medical images associated with the particular statement concerned. This is a burdensome and inefficient task. A system according to invention principles addresses this problem and associated problems.

### SUMMARY OF THE INVENTION

A system uses, imaging device orientation, location and inclination data (such as fluoroscopy head angular data) and a derived table identifying anatomical regions viewed at particular angles, to advantageously create a link between a report statement and a specific image or series of images. The system enables a user to view a DICOM imaging report of a patient automatically associating a patient image and a corresponding report statement. A system identifies an anatomical portion of a patient using positional data derived from an imaging device. The system includes an acquisition processor for acquiring positional data of a directional image acquisition unit oriented to acquire an image of a particular anatomical portion of a patient. The positional data corresponds to a particular orientation used to acquire a particular image of the particular anatomical portion of the patient. A repository of mapping data links positional data of the image acquisition unit with data identifying anatomical portions of a patient. An image data processor associates the particular image derived using the image acquisition unit with a particular anatomical portion of a patient using the mapping data.

### BRIEF DESCRIPTION OF THE DRAWING

FIG. 1 shows a medical imaging report generation system automatically linking medical images, report statements and anatomical portions of a patient using positional data derived from an imaging device, according to invention principles.

FIG. 2 illustrates a table associating anatomical views and rules for associating medical imaging device positional data with a corresponding view, according to invention principles.

FIG. 3 illustrates anatomical image views that may be associated with medical imaging device positions, according to invention principles.

FIG. 4 illustrates a fluoroscopy imaging device, according to invention principles.

FIG. 5 shows a flowchart of a process employed by a medical imaging report generation system, according to invention principles.

FIG. 6 shows a process sequence employed by a medical imaging report generation system, according to invention principles.

FIG. 7 shows a user interface configuration image used by a medical imaging report generation system, according to invention principles.

FIG. 8 shows a cardiac catheterization medical imaging report, according to invention principles.

FIG. 9 illustrates parsing of a cardiac catheterization medical imaging report, according to invention principles.

FIG. 10 shows a table indicating rules for use in matching medical imaging device positional data with medical report statements, according to invention principles.

FIG. 11 shows acquired DICOM header data including medical imaging device positional data and other data, according to invention principles.

FIG. 12 illustrates application of rules to acquired DICOM header data for use in matching medical imaging device positional data with medical report statements, according to invention principles.

FIG. 13 shows a cardiac catheterization medical imaging report including automatically incorporated hyperlinks to associated medical images, according to invention principles.

### DETAILED DESCRIPTION OF THE INVENTION

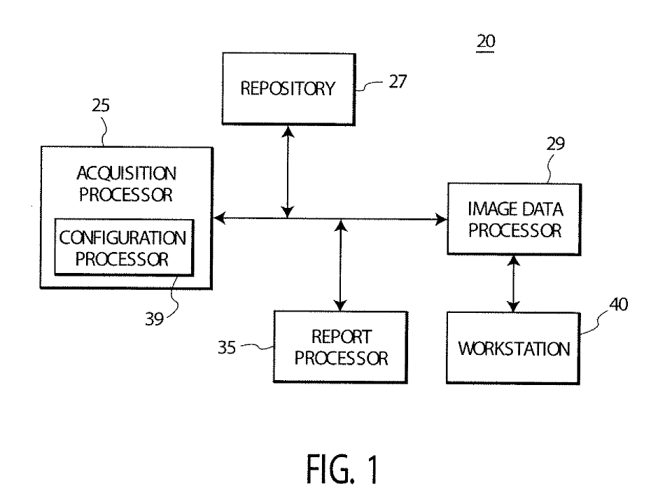

FIG. 1 shows a medical imaging report generation system automatically linking medical images, report statements and anatomical portions of a patient using positional data derived from an imaging device. The system creates links within a DICOM compatible Catheterization report, for example, to enable user viewing of medical images associated with a corresponding report statement. In contrast, existing systems require a user to flag an image and link a statement to the flag. A user is able to configure one or more matching report statements to be associated with imaging data of a particular anatomical region and determine the type of statement (e.g., a statement detail level such as whether it is a report title, section heading, diagnosis, procedural etc.) to be linked to images. The selection of a DICOM Report for viewing triggers the medical imaging report generation system to display data identifying one or more image studies (or images thereof) that match report statements and allows a user to directly initiate execution of an appropriate viewer application for the images. The medical imaging report generation system is configurable to initiate execution of either, a web viewer application on a non-post processing workstation application, or a diagnostic viewer application on a post processing workstation. The system automatically displays data from which a report statement was created based on matching statements identified in response to predetermined matching criteria configured by a user.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

FIG. 1 shows a medical imaging report generation system 20 automatically linking medical images, report statements and anatomical portions of a patient using positional data derived from an imaging device. Acquisition processor 25 acquires positional data of a directional image acquisition unit (such as an imaging device fluoroscopy head) oriented to acquire an image of a particular anatomical portion of a patient. The acquisition processor acquires the positional data and contrast imaging agent volume data, from DICOM compatible header data, for example, by automatically parsing the header data to identify data fields associated with predetermined DICOM header tags. The system uses positional data of a fluoroscopy head to determine anatomical regions being viewed. Based on the positional data (coordinates) of the fluoroscopy head, a heart region being viewed by a user is determined, such that a fluoroscopy head in an AP view is linked to statements regarding the Left main portion of the heart, for example. This is dynamically performed using coordinates of each image series view that are stored in a DICOM header within an image study. The position of a fluoroscopy head is stored within each DICOM image series captured during a catheterization procedure, for example. The positional data is stored as right to left, head to foot angular data within each image series. The system uses this data to identify the anatomical portion being viewed. A user configures the ranges of angular data and whether contrast imaging agent dye fluid volumes are injected in order to automatically and dynamically map to statements in an imaging report.

The positional data comprises data indicating at least one of, positional Cartesian coordinates (having dimensions of length), positional polar coordinates and angular data (in degrees). The positional data corresponds to a particular orientation used to acquire a particular image of the particular anatomical portion of the patient. Repository 27 includes mapping data linking positional data of image acquisition unit 25 with data identifying anatomical portions of a patient. Image data processor 29 associates a particular image derived using image acquisition unit 25 with a particular anatomical portion of a patient using mapping data in repository 27. The mapping data associates multiple different ranges of the positional data with data identifying corresponding multiple different anatomical portions of a patient. Configuration processor 39 in acquisition unit 25 enables a user to configure the mapping data by determining the different ranges of the positional data corresponding to the multiple different anatomical portions of the patient. The configured mapping data determines particular positional data of the image acquisition unit linked with data identifying corresponding anatomical portions of a patient.

The mapping data also links contrast agent fluid quantities with corresponding data identifying anatomical portions of a patient. Image data processor 29 associates the particular image derived using image acquisition unit 25 with a particular anatomical portion of a patient using contrast agent fluid quantities together with imaging device positional data. Specifically, acquisition processor 25 acquires data indicating a contrast agent fluid quantity associated with the image of the particular anatomical portion of the patient and image data processor 29 associates the particular image with a particular anatomical portion of a patient using mapping data and the acquired contrast agent fluid quantity (having dimensions of volume).

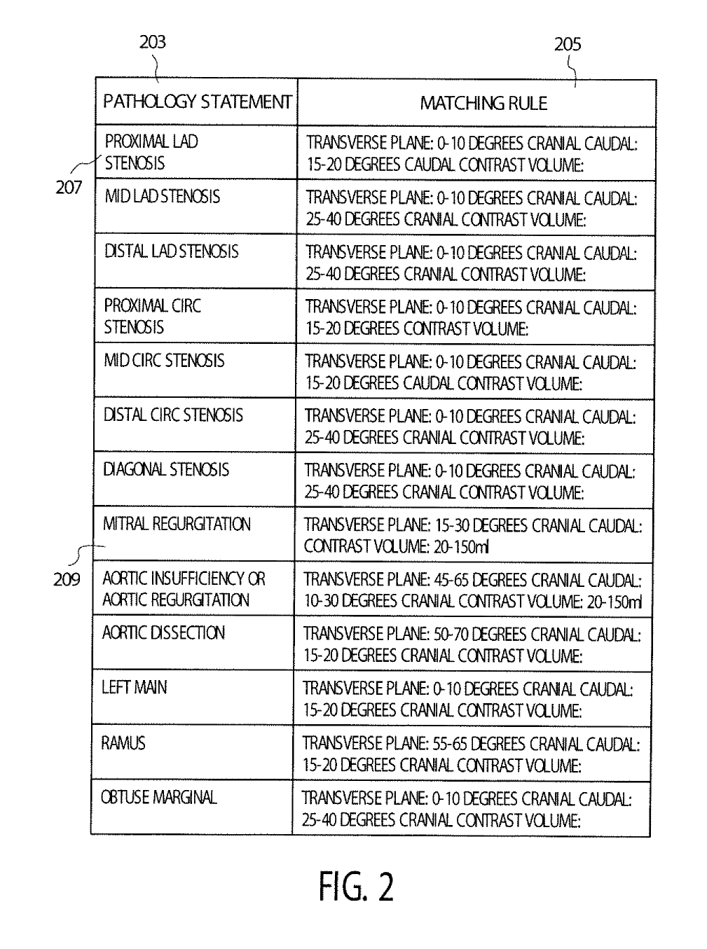

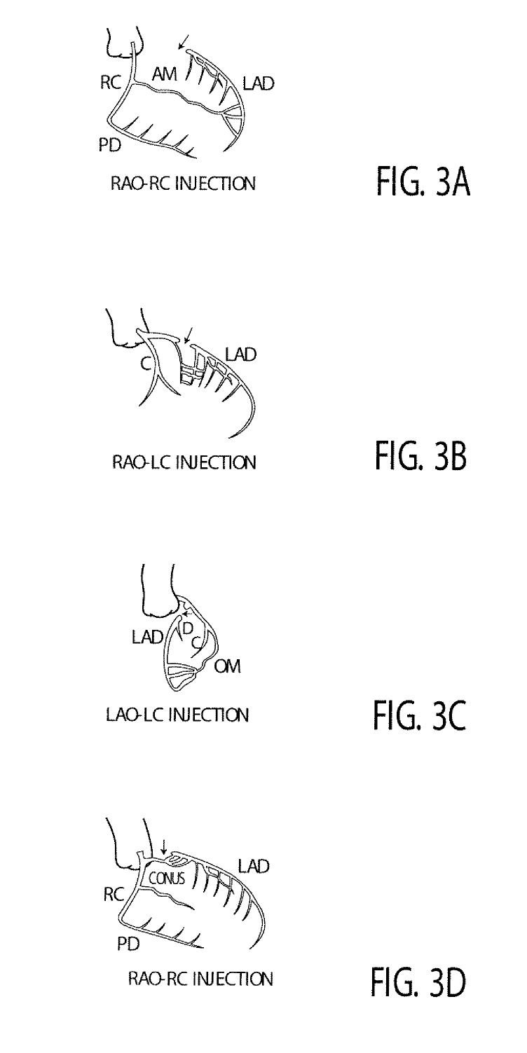

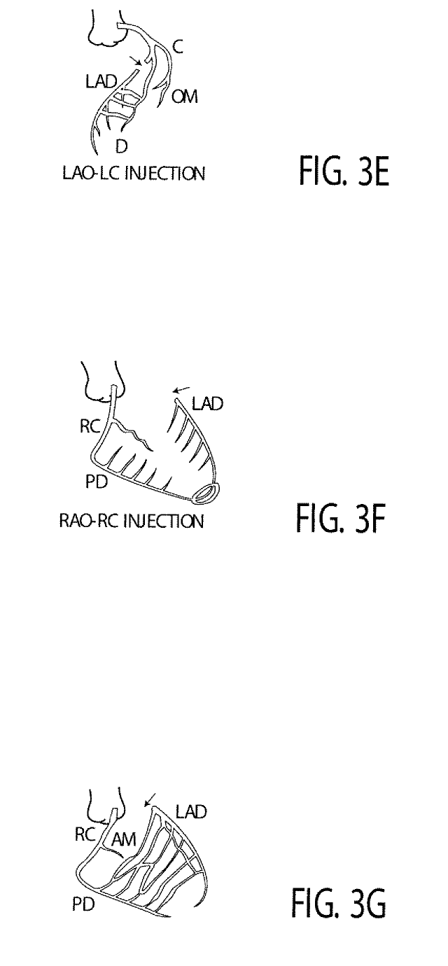

FIG. 2 illustrates a table associating anatomical views (and related medical report Pathology statements) and rules for associating medical imaging device positional data with a corresponding view. Column 203 identifies anatomical views (and related medical report Pathology statements) that are associated with corresponding rules for associating medical imaging device positional data in column 205. The Pathology statements of column 203 identify anatomical views that are associated with abnormalities of identified underlying anatomy. Row 207, for example, associates a Proximal LAD Stenosis view (and this term as used in a medical imaging report) with imaging device head positional data of 0-10 degrees in a transverse plane and 15-20 degrees cranial caudal. Row 209 associates a Mitral Regurgitation view (and this term as used in a medical imaging report) with imaging device head positional data of 15-30 degrees in a cranial caudal plane and a contrast volume of 20-150 milliliters. FIG. 3 illustrates anatomical image views that may be associated with medical imaging device positional data in the mapping data of repository 27 as partially illustrated in FIG. 2.

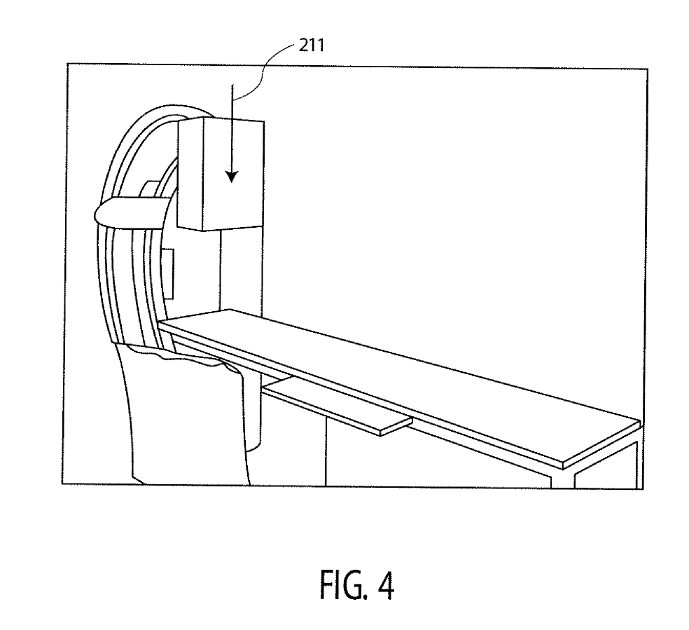

FIG. 4 illustrates a fluoroscopy imaging device. The position of fluoroscopy head 211 is specified in relationship to the heart so that angular data of the Fluoroscopy head from the fluoroscopy imaging device correlates to underlying imaged anatomy. Data indicating angular data of Fluoroscopy head 211 is used to automatically identify pathology of specific Fluoroscopy cine loops (DICOM compatible image series of patient anatomy) via mapping data (e.g., one or more tables in repository 27) linking pathology statements to angular data. The mapping data links pathology statements to angular ranges and contrast agent volumes and also to DICOM image series. A contrast agent is typically a dye introduced into human anatomy to enhance resulting images.

A report processor 35 (FIG. 1) uses the mapping data accessed from repository 27 to automatically associate a statement in an imaging report concerning the particular anatomical portion of the patient with the particular image derived using the image acquisition unit. The report processor does this by automatically parsing the imaging report to identify a statement referring to an image and by associating the identified statement with the particular image, using the mapping data. Report processor 35 also creates and incorporates, a user selectable link associated with the statement, in the imaging report, for accessing data representing the particular image. Report processor 35 accesses the data representing the particular image in response to user selection of the user selectable link and displays the particular image in an application image window selected in response to application context information. The particular image (or set of images) is displayed on workstation 40 together with the imaging report in different windows in a single composite image, for example, or in different images.

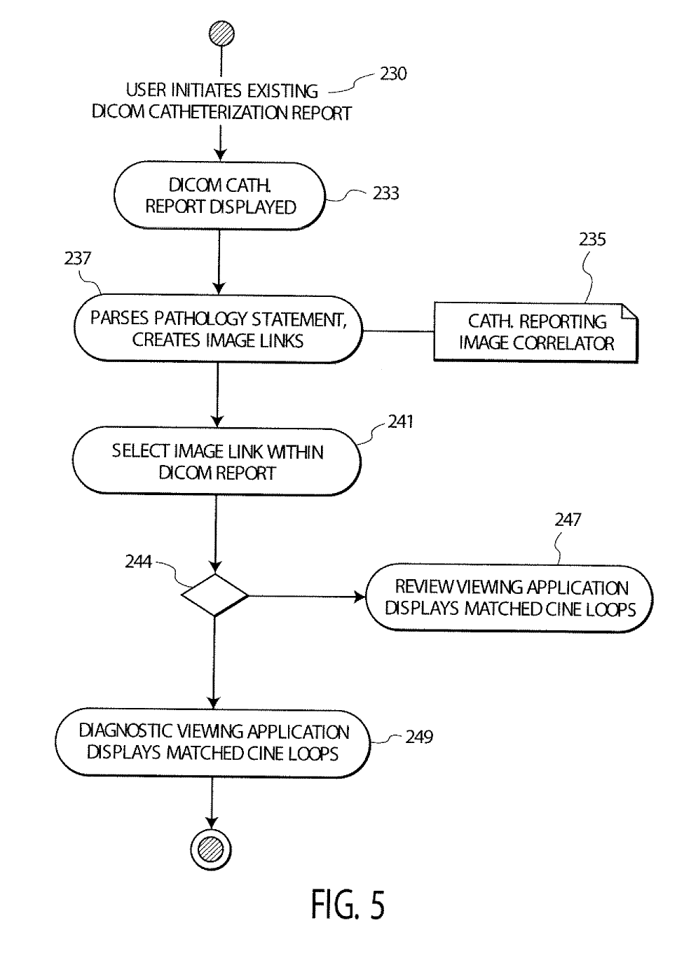

FIG. 5 shows a flowchart of a process employed by a medical imaging report generation system 20. A user initiates access to a DICOM catheterization report, for example, via workstation 40 in step 230. The catheterization report is displayed on workstation 40 in step 233. In step 235 and 237, report processor 35 operating in conjunction with image processor 29, employs mapping data in repository 27 to identify and associate statements in the catheterization report with corresponding medical images of a patient. Report processor 35 creates and incorporates links (e.g., hyperlinks) in the catheterization report for accessing corresponding associated medical images that are stored in repository 27 or another repository. A user in step 241 selects a created link and system 20, in step 244 in response to system context information, presents medical images such as an image series (e.g., fluoroscopy cine loop) on workstation 40 for review using a viewing application in step 247 or presents the image series on workstation 40 (or another workstation not shown in FIG. 1 for clarity reasons) for diagnostic viewing using a diagnostic viewing application in step 249. The system context information indicates an application currently being executed by system 20 and whether it is a review or diagnostic application, for example.

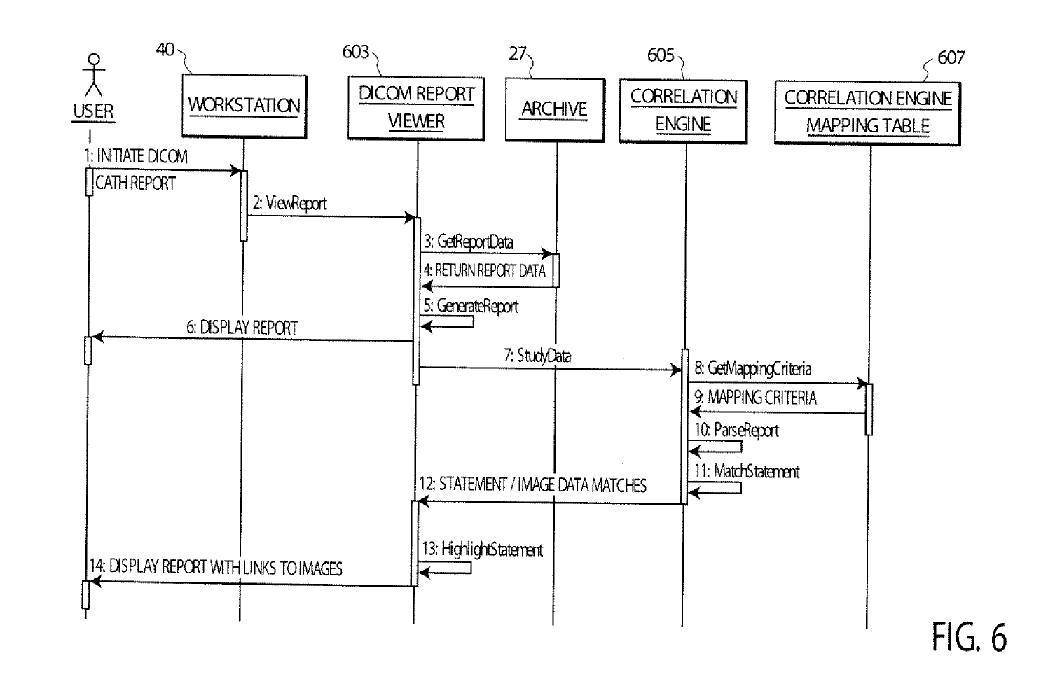

FIG. 6 shows a process sequence employed by medical imaging report generation system 20. In step 1, a user initiates access to a DICOM compatible catheterization report on workstation 40 (FIG. 1) for viewing using a report viewer application 603 in step 2. Report viewer application 603 in step 3, requests report data from repository 27 and in step 4 repository 27 returns the requested report data. Viewer application 603 employs the requested report data in generating a DICOM compatible catheterization report in step 5 for display to a user on workstation 40 in step 6. Report viewer application 603 sends image study data associated with the generated report to Correlation Engine 605 in report processor 35 in step 7 and Correlation Engine 605 requests mapping data from a Mapping table 607 in repository 27 in step 8. The mapping data is returned by repository 27 in step 9 and is used by correlation engine 605 to associate identified report statements with acquired images. Units 603, 605 and 607 may reside together or separately, in one or more units of system 20. In step 10 Correlation Engine 605 identifies and parses report statements based on their DICOM tags and in step 11 identifies statements that match associated individual or multiple images using match requirements acquired from mapping table 607. Correlation engine 605 in step 12 returns data, representing matched data pairs indicating catheterization report statements and corresponding images (e.g., identified by image series UIDs, study UIDs or individual image UIDs), to viewer application 603. Viewer application 603, in step 13, highlights catheterization report statements previously identified in step 11 as having matching images and displays the report including created hyperlinks in the matching statements to corresponding medical images on workstation 40 in step 12.

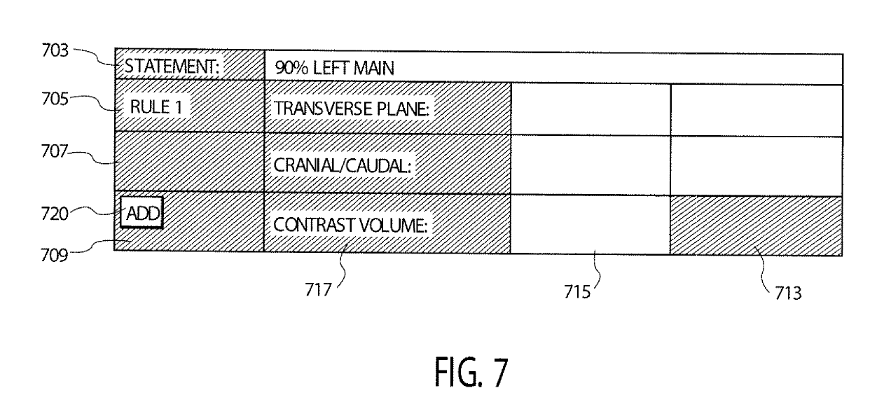

FIG. 7 shows a user interface configuration table used by medical imaging report generation system 20. Configuration processor 39 enables a user to configure an individual statement within a report to link it to particular imaging anatomical planes in accordance with matching rule criteria in the configuration table. Row 703 identifies an anatomical report statement and column 717 in rows 705 and 707 indicate anatomical planes associated with the statement and row 709 indicates contrast volume. Rows 705 and 707 of columns 713 and 715, enable a user to specify angular degree ranges of an imaging device head (e.g., a fluoroscopy head) associated with the anatomical image planes of column 717 and anatomical statement of row 703. Row 709 of column 715 enables a user to specify a contrast agent volume associated with the anatomical statement of row 703. A user is able to add any number of additional rules to match additional imaging planes to a report statement by adding columns or rows to the configuration image table in response to selection of add button 720.

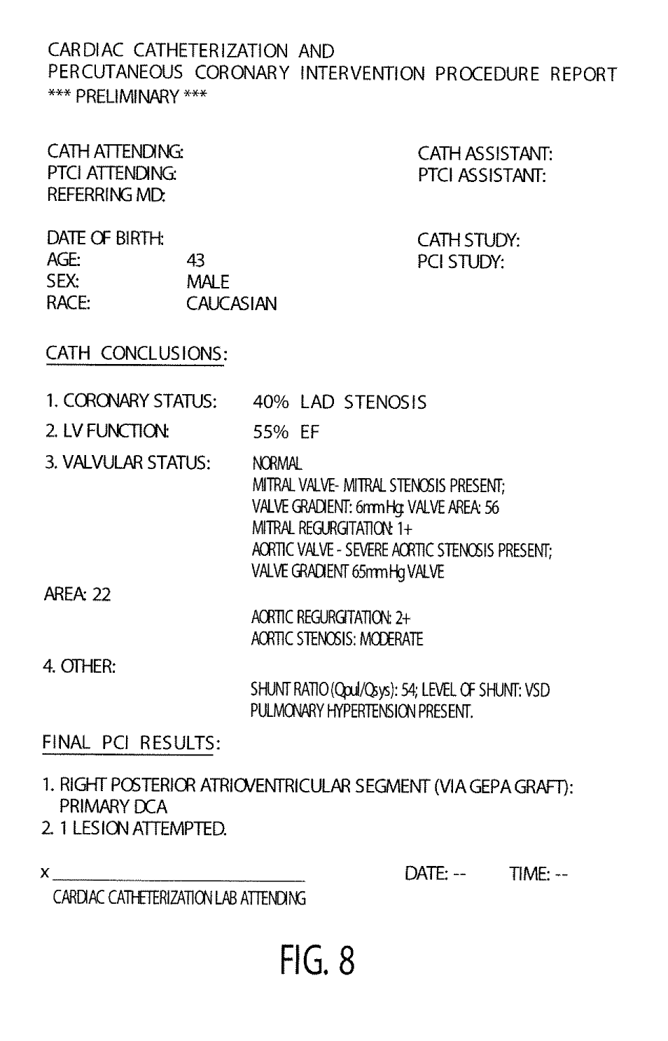

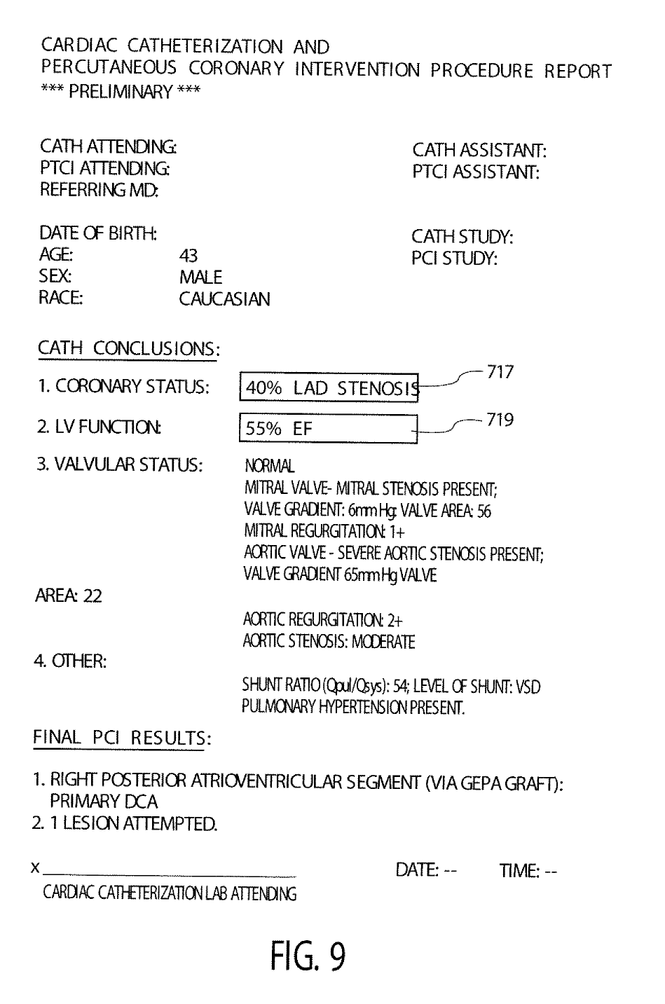

In operation, FIG. 8 shows an exemplary cardiac catheterization medical imaging report accessed and displayed via workstation 40 (FIG. 1). Report processor 35 operating in conjunction with image processor 29, automatically employs mapping data in repository 27 to identify and associate statements in the catheterization report with corresponding medical images of a patient. Report processor 35 automatically parses the catheterization report using one or more database tables (mapping data acting as a rules engine). The mapping data provides criteria comprising a set of rules for identifying report statements and associating them with patient medical images. Report processor 35 uses the mapping data in automatically identifying report statements 717 and 719 as indicated in FIG. 9 derived by parsing the cardiac catheterization medical imaging report. A user is able to configure the mapping data to associate imaging data of a particular anatomical region with a particular type of statement (e.g., a statement detail level such as whether it is a report title, section heading, diagnosis, procedural etc.) used by report processor 35 in automatically identifying report statements.

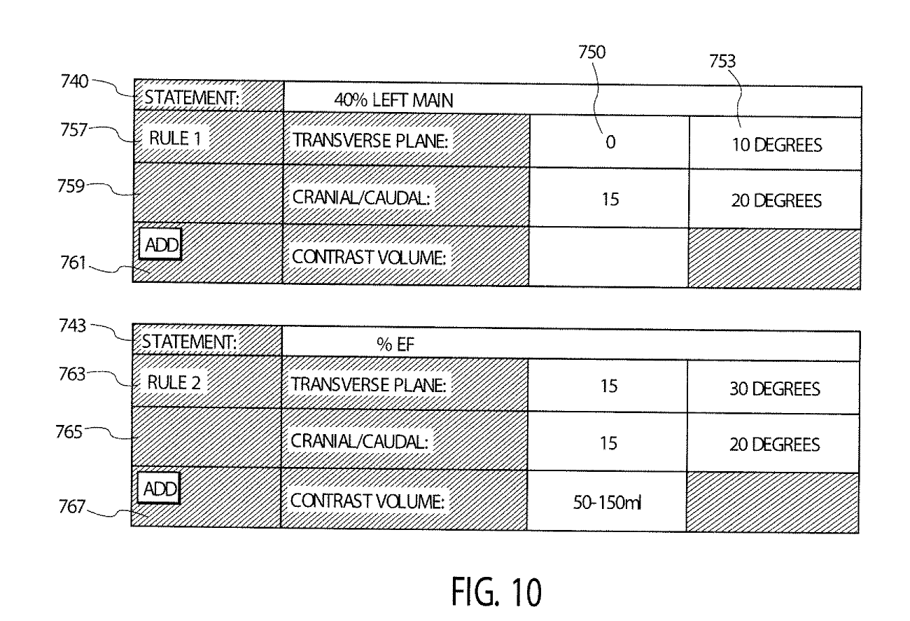

FIG. 10 shows a database table comprising rules 1 and 2 for use in matching medical imaging device positional data with medical report statements. Report processor 35 parses individual statements in the catheterization report to identify statements matching statements in row 740 (40% Left Main) of Rule 1 and 743 (% EF) of Rule 2. In response to a statement match, report processor 35 initiates communication of a query to interrogate a DICOM image study acquired by acquisition processor 25 and stored in system 20 in unit 25, repository 27 or elsewhere. Report processor 35 queries header data of a DICOM image study to identify appropriate DICOM tags (e.g., tags 0018, 1450; 0018, 1510; 0018, 1511 and 0018, 1041) and retrieve data corresponding to identified tags. The retrieved data is converted to an alphanumeric data representation.

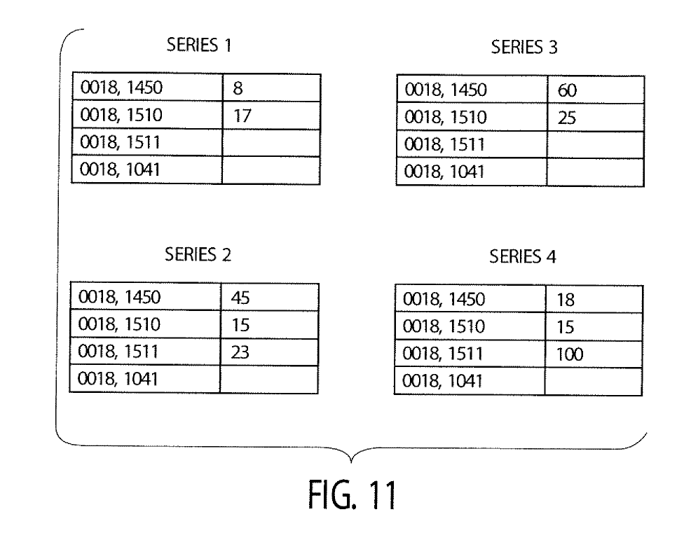

FIG. 11 shows retrieved DICOM header data including medical imaging device positional data and other data. The retrieved data is converted to an alphanumeric data representation as exemplified in the retrieved image study header data for four image series (series 1, series 2, series 3 and series 4). Image series 1 shows retrieved data values of 8 and 17 for tag values 0018, 1450 and 0018, 1510, respectively. Similarly, Image series 2 shows retrieved data values of 45, 15 and 23 for tag values 0018, 1450; 0018, 1510 and 0018, 1511, respectively. Image series 3 shows retrieved data values of 60 and 25 for tag values 0018, 1450 and 0018, 1510, respectively. Image series 4 shows retrieved data values of 18, 15 and 100 for tag values 0018, 1450; 0018, 1510 and 0018, 1511, respectively. Report processor 35 applies Rules 1 and 2 of FIG. 10 to the retrieved header data of FIG. 11. The units of data items having tag values 0018, 1450; 0018, 1510; and 0018, 1511 are degrees and units of data items having tag values 0018, 1041 are mls (milliliters).

A contrast imaging agent (dye) volume value indicated in a DICOM header of an image series is used in a mapping data Pathology statement table (e.g., row 39 of FIG. 2) to allow a correlation engine in report processor 35 to automatically match aortography (large amounts of dye are needed versus a coronary angiography) and left Ventriculography statements, for example, to corresponding images. The correlation engine uses the field data for DICOM Tag 0018, 1041, for example, to further define image matching criteria. An exemplary user configured rule indicates a volume of contrast imaging agent liquid to match, and if the field data in 0018, 1041 is within that fluid range, the rule applies.

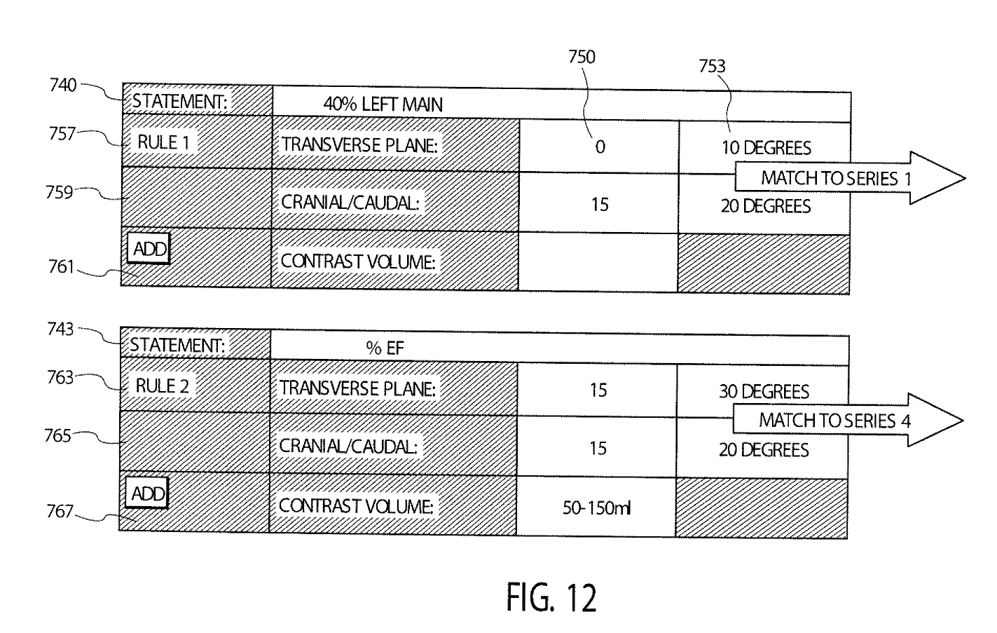

FIG. 12 illustrates application of rules of FIG. 10 to the retrieved DICOM header data of FIG. 11 used by report processor 35 in matching medical imaging device positional data and contrast agent volume data with medical report statements. FIG. 12 shows that the 8 degree transverse plane angular value and the 17 degree Cranial/Caudal plane angular value of image series 1 (FIG. 11) meet the Rule 1 associated ranges of 0-10 degrees and 15-20 degrees respectively. Similarly, the 18 degree transverse plane angular value, the 15 degree Cranial/Caudal plane angular value and the 100 ml contrast imaging agent volume value of image series 4 meet the Rule 2 associated ranges of 15-30 degrees, 15-20 degrees and 50-150 ml contrast agent fluid volume, respectively.

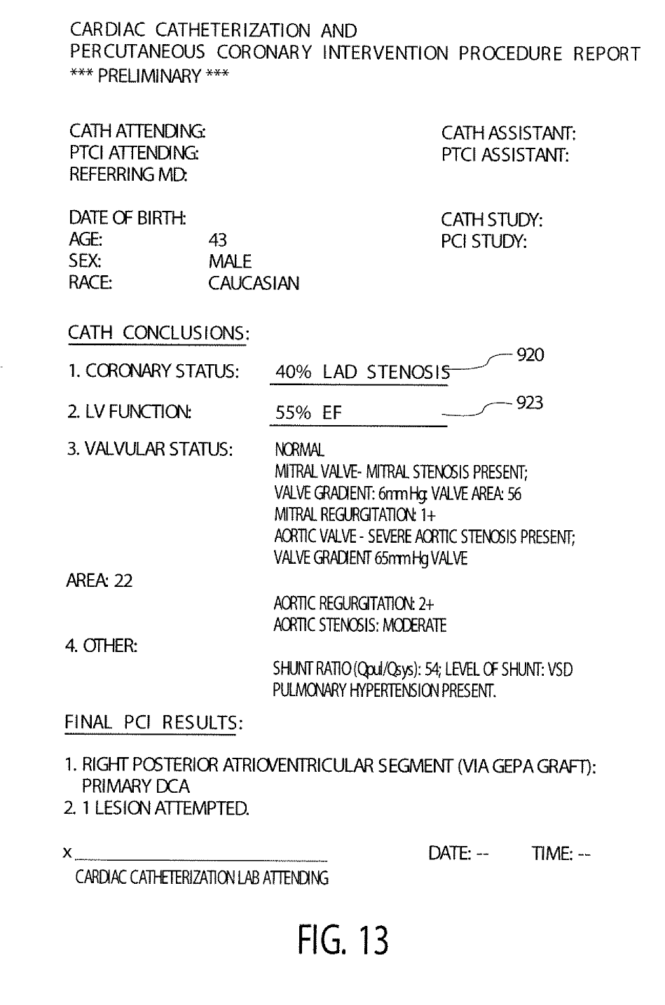

In response to the rule matching, report processor 35 automatically creates hyperlinks and incorporates the links 920 and 923 in the catheterization report as illustrated in FIG. 13. Links 920 and 923 in the catheterization report enable a user to access corresponding associated medical images that are stored in repository 27 or another repository. A user selects link 920 or 923 and system 20, in response to system context information, presents medical images such as an image series (e.g., fluoroscopy cine loop) on workstation 40 for review using a viewing application or presents the image series on workstation 40 (or another workstation not shown in FIG. 1 for clarity reasons) for diagnostic viewing using a diagnostic viewing application. The system context information indicates an application currently being executed by system 20 and whether it is a review or diagnostic application, for example.

System 20 advantageously automates image and report statement correlation and enables a single report statement to have multiple image series (e.g., fluoroscopy cine loops) associated with it based on data contained within an individual image series DICOM attributes. System 20 is able to automatically link a single report statement to any number of anatomical imaging planes, for example. Image series matching configured criteria are presented to a user in order of their series number. If there are no image series with data matching the statement (the statement is in the matching table, but the criteria in the rule have no matching images in an image study) no match is shown to a user. System 20 does not allow duplicate report statements to be associated with rules for identifying matching image data. A user is prompted to add a new matching rule to a configured statement. System 20 is usable for automated matching of nuclear cardiology report statements to nuclear cardiology image sets, for example. System 20 automatically links reports and report statements to images in a distributed web environment for referring physicians and facilitates access to patient imaging data in a structured manner.

A correlation engine in report processor 35 extracts pathology statements that identify anatomical views that are associated with abnormalities of identified underlying anatomy, from a DICOM report. The correlation engine uses these in a mapping data Pathology statement table to retrieve associated angular information corresponding to a particular Pathology statement. Report processor 35 employs DICOM image series header information referenced by a specific DICOM imaging report together with angular information associated with an image series (e.g., cine loop) to access specific images in the image series. The mapping data Pathology statement table is created by a user that knows the relationship between pathology and angular information. In another embodiment the mapping data Pathology statement table is created automatically from imaging device data.

The system and processes presented in FIGS. 1-13 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and processes of FIGS. 1-13 may be implemented in hardware, software or a combination of both. Individual functions indicated in system 20 may be combined into one or more executable application functions and reside in any of the units of system 20.

What is claimed is:

1. A system for identifying an anatomical portion of a patient using positional data derived from an imaging device, comprising:
an acquisition processor for acquiring positional data of a directional image acquisition unit oriented to acquire an image of a particular anatomical portion of a patient, said positional data corresponding to a particular orientation used to acquire a particular image of said particular anatomical portion of said patient;
a repository of mapping data linking positional data of said image acquisition unit with data identifying anatomical portions of a patient; and
an image data processor for associating said particular image derived using said image acquisition unit with a particular anatomical portion of a patient using said mapping data.

2. A system according to claim 1, wherein
said mapping data associates a plurality of different ranges of said positional data with data identifying a corresponding plurality of different anatomical portions of a patient.

3. A system according to claim 2, including
a configuration processor enabling a user to configure said mapping data by determining said different ranges of said positional data corresponding to said plurality of different anatomical portions of said patient.

4. A system according to claim 1, including
a configuration processor enabling a user to configure said mapping data by determining particular positional data of said image acquisition unit linked with corresponding data identifying corresponding anatomical portions of a patient.

5. A system according to claim 1, wherein
said mapping data links contrast agent fluid quantities with data identifying anatomical portions of a patient; and
said image data processor associates said particular image derived using said image acquisition unit with a particular anatomical portion of a patient using said contrast agent fluid quantities.

6. A system according to claim 5, wherein
said acquisition processor acquires data indicating a contrast agent fluid quantity associated with said image of said particular anatomical portion of said patient and
said image data processor associates said particular image with a particular anatomical portion of a patient using mapping data and said acquired contrast agent fluid quantity.

7. A system according to claim 6, wherein
said contrast agent fluid quantity is in a dimension of volume.

8. A system according to claim 1, wherein
said image data processor automatically associates a statement in an imaging report concerning said particular anatomical portion of said patient with said particular image derived using said image acquisition unit, using said mapping data.

9. A system according to claim 1, wherein
said positional data comprises data indicating at least one of, (a) positional Cartesian coordinates, (b) positional polar coordinates and (b) angular data.

10. A system according to claim 1, wherein
said positional Cartesian coordinates are in length dimensions and said angular data is in degrees.

11. A system according to claim 1, wherein
said acquisition processor acquires said positional data from DICOM compatible header data by automatically parsing said header data to identify data fields associated with predetermined DICOM header tags.

12. A system according to claim 11, wherein
said acquisition processor acquires contrast imaging agent volume data from DICOM compatible header data by parsing said header data to identify data fields associated with predetermined DICOM header tags.

13. A system for identifying an anatomical portion of a patient using positional data derived from an imaging device, comprising:
an acquisition processor for acquiring positional data of a directional image acquisition unit oriented to acquire an image of a particular anatomical portion of a patient, said positional data corresponding to a particular orientation used to acquire a particular image of said particular anatomical portion of said patient;
a repository of mapping data linking positional data of said image acquisition unit with data identifying anatomical portions of a patient; and
a report processor for automatically associating a statement in an imaging report concerning said particular anatomical portion of said patient with said particular image derived using said image acquisition unit, using said mapping data by creating and incorporating, a user selectable link associated with said statement, in said imaging report, for accessing data representing said particular image.

14. A system according to claim 13, wherein
said report processor automatically parses said imaging report to identify a statement referring to an image and associates said identified statement with said particular image, using said mapping data.

15. A system according to claim 13, wherein
said report processor accesses said data representing said particular image in response to user selection of said user selectable link and displays said particular image in an application window selected in response to application context information.

16. A system for identifying an anatomical portion of a patient using positional data derived from an imaging device, comprising:
an acquisition processor for acquiring positional data of a directional image acquisition unit oriented to acquire an image of a particular anatomical portion of a patient, said positional data corresponding to a particular orientation used to acquire a particular image of said particular anatomical portion of said patient;
a repository of mapping data linking positional data of said image acquisition unit with data identifying anatomical portions of a patient; and
a report processor for automatically parsing an imaging report concerning said particular anatomical portion of said patient to identify a statement referring to an image and associating said identified statement with said particular image, using said mapping data by creating and incorporating, a user selectable link associated with said statement, in said imaging report, for accessing data representing said particular image.

17. A system according to claim 16, wherein
said acquisition processor acquires said positional data from DICOM compatible header data by automatically parsing said header data to identify data fields associated with predetermined DICOM header tags.

18. A system according to claim 17, wherein
said acquisition processor acquires contrast imaging agent volume data from DICOM compatible header data by parsing said header data to identify data fields associated with predetermined DICOM header tags.
